(19) United States
(12) Patent Application Publication
(10) Pub. No.: US 2008/0191472 A1
(43) Pub. Date: Aug. 14, 2008

(54) Flexible Hose and Method for Mounting a Coupling Nut on a Flexiblehose

(75) Inventor: Uwe Vieregge, Fulda (DE)

Correspondence Address: DENNISON, SCHULTZ & MACDONALD, 1727 KING STREET, SUITE 105, ALEXANDRIA, VA, 22314, US

(73) Assignee: Salzgitter Stahlhandel GmbH, Dusseldorf (DE)

(21) Appl. No.: 11/996,629

(22) PCT Filed: Jul. 25, 2006
(86) PCT No.: PCT/EP06/07286

§ 371 Date: Mar. 3, 2008

(30) Foreign Application Priority Data
Jul. 25, 2005 (DE) 20 2005 011 642.4

(51) Int. Cl. F16L 33/01

(52) U.S. Cl. 285/256

(57) ABSTRACT

A flexible sprinkler hose includes an inner corrugated hose, enclosed by a braiding with a terminal coupling nut connected to the hose for connection to a fitting. According to the invention, a secure connection between the hose and the coupling nut may be achieved with a simple construction, by a terminal smoothing of the corrugated tube, a support sleeve running between the smoothed terminal region of the corrugated hose and the braiding, the braiding being fixed between the support sleeve, a clamping sleeve enclosing the support sleeve and the smoothed terminal region is enclosed by the coupling nut including a shoulder running in the direction of the support sleeve. The above is provided with a stop element to prevent a withdrawal of the coupling sleeve element on coupling to the fitting and a flange-shaped terminal section of the terminal region of the corrugated tube is fixed between the coupling nut and the fitting.

The invention relates to a flexible hose, in particular a sprinkler hose, comprising an inner corrugated hose, which is surrounded on the outside by a braiding, as well as a coupling sleeve element such as a coupling nut that is connected to the hose on the end side, for connection to a component such as a fitting. In addition, the invention refers to a method of mounting a coupling-sleeve element, such as a coupling nut, on a flexible hose, such as a sprinkler hose, which comprises an inner corrugated hose that is enclosed on the outside by a braiding.

A corresponding sleeve, with a coupling nut as coupling-sleeve element and a fitting as a component, is disclosed by WO-A-02/070071. The sleeve is configured as socket sleeve, which is connected with a tube-shaped connecting element by means of a snap ring. In addition, the socket sleeve is welded, on the one hand, to the hose, and on the other, to the annular element encompassing its casing. This kind of connection between sleeve and hose is permanent and features the required tightness.

Flexible hoses are also known from U.S. Pat. No. 3,023,496 or EP-A-0 503 369, which have sleeves to receive fittings, or as the case may be, tubes that are welded to each other.

This invention is based on the task of further developing a hose of the type cited at the beginning, particularly in the form of a sprinkler hose, in such a way that through simple constructive measures, a secure connection between the sleeve and the hose is provided without the necessity of welding. Tightness between the sleeve and a fitting that is to be connected with it, said fitting being a hose or tube section, should be achieved, as the case may be, also without additional sealant. In addition, by means of the invention of the method cited at the beginning, the invention should be further developed in such a way that it will be possible to secure a coupling-sleeve element such as coupling nut on a flexible hose using simple constructive means, whereby when connecting the hose to a component, the forces, as the case may be, are to be transferred via the braiding.

In terms of the invention, the task relating to the flexible hose is resolved essentially in that the corrugated hose is smoothed at its end side, that a support sleeve runs between the smoothed end region of the corrugated hose and the braiding, that the braiding is fixed between the support sleeve and a clamping sleeve surrounding the support sleeve, that the smoothed end region is surrounded by the coupling-sleeve element, which features a shoulder extending in the direction of the support sleeve, whereby in the case of the coupling-sleeve element being connected to the component, the coupling-sleeve element is assigned a stop element that prevents withdrawal of the coupling-sleeve element from the hose, and a flange-shaped end section of the smoothed end region of the corrugated hose is fixed between the coupling-sleeve element and the component.

In terms of the invention, the hose is connected by purely mechanical means, without the necessity of a material fit, with the coupling-sleeve element, which is preferably configured as a coupling nut for connection with the component such as fitting, which for example, could also be the section of a hose or tube. Making a connection, for example, by screwing the component, is thereby possible in a particularly simple way, when the coupling nut can be revolved in relation to the hose. According to one embodiment, there is also the advantage that forces are conducted via the braiding of the hose, because the hose is fixed in place by pressing the clamp sleeve around the support sleeve, so that as a result, the tensile forces that are conducted via the coupling-sleeve element are transferred to the braiding.

In order to ensure that the coupling-sleeve element cannot be withdrawn from the hose, said element features a shoulder running in the direction of the hose that rests against a stop when the coupling-sleeve element is connected to the component. The stop can be formed by a radially protruding section of the support sleeve and/or the clamping sleeve. According to another embodiment, the stop is formed by a ring, or as the case may be an annular element that projects respectively beyond the support sleeve and the clamping sleeve, and is secured in an axial direction between them.

The annular element can be comprised of assembled half-rings or half-shells, so that it is possible to insert them into the interspace that runs axially between the support sleeve and the clamping sleeve. However, there is also the possibility of forming the stop element by means of an annular or hollow-cylinder element that is arranged between the front surface of the supporting sleeve on the component side and the reshaped flange-like end section of the corrugated hose.

If the stop element is formed by the annular element running outside the support sleeve and clamping sleeve, the axial forces are not conducted via the braiding of the hose, but rather via the corrugated hose itself. A corresponding introduction of force also occurs when the reshaped flange-like end section of the corrugated hose is clamped directly between the coupling-sleeve element and the component, without a stop for the coupling-sleeve element being present additionally. In this case, the stop is formed instead by the reshaped flange-like end section and the component in the area in which the coupling-sleeve element rests against the component.

In order to mount the coupling-sleeve element, it is first plugged onto the hose. Then the braiding is retracted from the end of the corrugated hose, which is then smoothed, if there is not already a smoothed end section. The support sleeve is slid onto the smooth end of the corrugated hose. The braiding is pulled along the outside of the supporting sleeve. The corresponding area is then surrounded on the peripheral side by the clamping sleeve, which is subsequently pressed. This creates a force-fit connection between the support sleeve and clamping sleeve and the braiding running between them. The smooth end of the corrugated hose, which overlaps axially on the inside with the support sleeve, is then reshaped into a flange, i.e. widened and bent outward, or formed into a fold, which can be used, for example, to fix a sealing ring.

Independently of this, the free end region of the corrugated hose can extend along the radially running free front surface of the support sleeve to such an extent that the corresponding area is clamped indirectly or directly between the component and the support sleeve. When it is clamped directly between the component and support sleeve, the end area of the corrugated hose forms the necessary seal. Preferably, however, a sealing, such as an annular seal, extends between the component and the border area of the corrugated hose that runs along the front surface of the support sleeve.

Alternatively, the flange-like end area of the smoothed corrugated hose can be clamped between the annular element that serves as a stop element and the component, whereby a sealing, such as an annular seal, runs between the flange-like end section and the component.

Direct clamping between the stop and the component is also possible. In this case, the flange-like end section should run inclined relative to the longitudinal axis of the hose, or as the case may be, the sleeve.

In addition, the coupling-sleeve element can be pushed along the hose in the direction of the free outer end of the support sleeve, whereby the encompassing shoulder of the coupling-sleeve element prevents withdrawal from the hose by being arrested, either by the annular element, which is comprised preferably of two half-rings, or as the case may be half-shells, or of an outer flange-like edge of the support sleeve that is bent outward, or the further annular or hollow-cylinder element as stop.

In particular, as cited above, there is also the possibility that in the case of a component that is connected to the coupling-sleeve element, the component itself performs the function of the stop, which is when the flange-like end section of the corrugated hose smoothed at the end side is clamped between the component and the coupling-sleeve element. In this case, the end section takes the form of a trumpet-shaped extension, which is also called a flange.

The flange can consist of a single or a double, i.e. folded section of the smoothed corrugated hose, whereby there is also a possibility that the flange is a section of a fold.

In terms of the invention, the stop can also be the hollow-cylinder element, or as the case may be, annular element that runs between the support sleeve and the flange-like section, the component side front surface of which running perpendicular to the longitudinal axis of the socket sleeve or at an angle to it. The angular course is selected particularly when the flange-like end section of the corrugated hose is fixed without additional sealing between the component and the coupling-sleeve element and also exercises a sealing function.

Preferably, however, a sealing element, such as a ring seal, runs between the component and the surface of the flange-like section of the hose facing it.

It is provided in particular that the supporting sleeve, in cross-section, shows an H-form lacking of a transverse limb, whereby the clamping sleeve runs between its outwardly bent edges, whose axial extent is however smaller than the clear distance of the section of the support sleeve that extends in the axial direction of the hose. Said support sleeve therefore features the geometry of hollow cylinder with the edges or flanges bent outward at the end side.

The clamping sleeve is force-fittingly pressed around the support sleeve in such a way—with simultaneous clamping of the braiding—that the element, such as half rings or shells, forming the stop for the coupling nut can be inserted between the component-side front edge of the clamping sleeve and facing surface of the outwardly bent edge region of the support sleeve.

If the end area of the smoothed hose section is configured as a fold, the flange section extends along the outside surface of the supporting sleeve, or as the case may be the annular or hollow-cylinder element that runs between the support sleeve and the flange section and forms the stop for the coupling-sleeve element. On the opposite side of the flange section, and on the outer shoulder of the fold that runs in an axial direction, there is then preferably a sealing element, which can be fixed between the coupling-sleeve element and the flange section of the hose when connecting said coupling-sleeve element to the component.

If the flange-like end area is fixed between the component and the element that runs between the supporting sleeve and the flange-like end section, the axial forces will essentially be transferred exclusively via the flange-like section of the corrugated hose, and not via the support sleeve and the braiding.

The coupling-sleeve element, in particular, is a coupling nut that can be screwed to a component such as a fitting. Other embodiments are also possible. The interior of the coupling nut can also be configured with an undercut. However, there is also the possibility of designing the coupling-sleeve element without a thread, e.g. in order to establish a connection with a component via a flange connection. In this case, it is also not necessary for the coupling-sleeve element to be rotatable relative to the hose. Rather, after mounting the coupling-sleeve element can be prevented from turning by e.g. flanging.

The sleeve-shaped, or as the case may be, annular elements can consist of non-alloyed, or as the case may be, rust-proof high-grade steel. The surfaces feature treatment suitable for the intended use. A KTL or DACROMET coating is possible. Galvanization can also be done.

With a KTL coating that is not metallic, there is the advantage that this produces an electrically non-conductive protective surface, whereby potential crevice corrosion is avoided.

The sealing to be used can work according to the flat-seal principle. The sealing material is adjusted to the case of operation, and is chosen depending on the temperatures and pressures that prevail, as well as the medium flowing through the hose.

A method for mounting a coupling-sleeve element and a coupling nut on a flexible hose, such as a sprinkler hose, comprising an inner corrugated hose, which is surrounded on the outside by a braiding, is characterized by the following procedural steps:
retracting the braiding from one end of the corrugated hose,
smoothing the exposed end area of the corrugated hose,
pushing a support sleeve onto the smoothed end area of the corrugated hose,
surrounding the support sleeve with braiding that is drawn over it,
encompassing at least sections of the support sleeve with a clamping sleeve in the area of the support sleeve that are surrounded by the braiding,
a force-fitted connection of the clamping sleeve to the support sleeve,
reshaping the smoothed corrugated hose that protrudes axially beyond the support sleeve into a flange-shaped section,
   whereby the coupling-sleeve element is pushed onto the hose before or after applying the support sleeve, and whereby the support sleeve and/or the clamping sleeve and/or an element that is inserted between the flange-like section of the smoothed corrugated sleeve and the support sleeve, and/or a component that can be connected to the coupling-sleeve element is a stop against withdrawal of the coupling-sleeve element.

Additional details, advantages, and features of the invention are found not only in the claims, the characteristics seen in them—individually and/or in combination—but also from the following description of the preferred embodiments that can be seen in the drawing.

It shows:

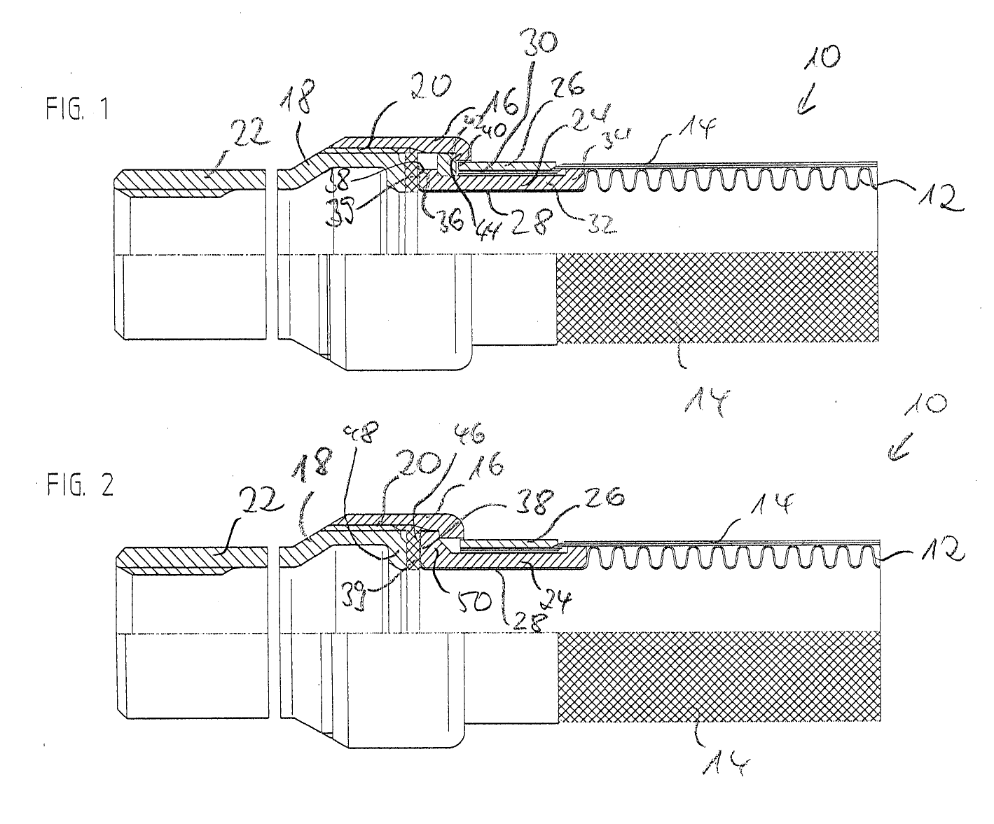

FIG. 1 a first embodiment of a hose,

FIG. 2 a modification of the embodiment according to FIG. 1,

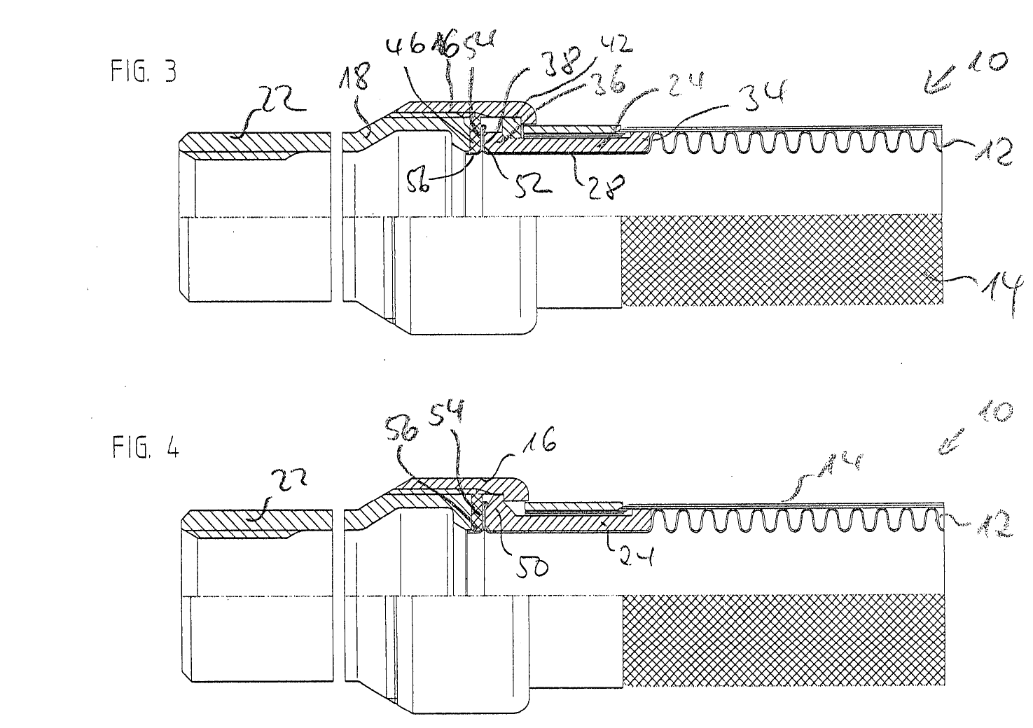

FIG. 3 a second embodiment of a hose,

FIG. 4 a modification of the hose according to FIG. 3,

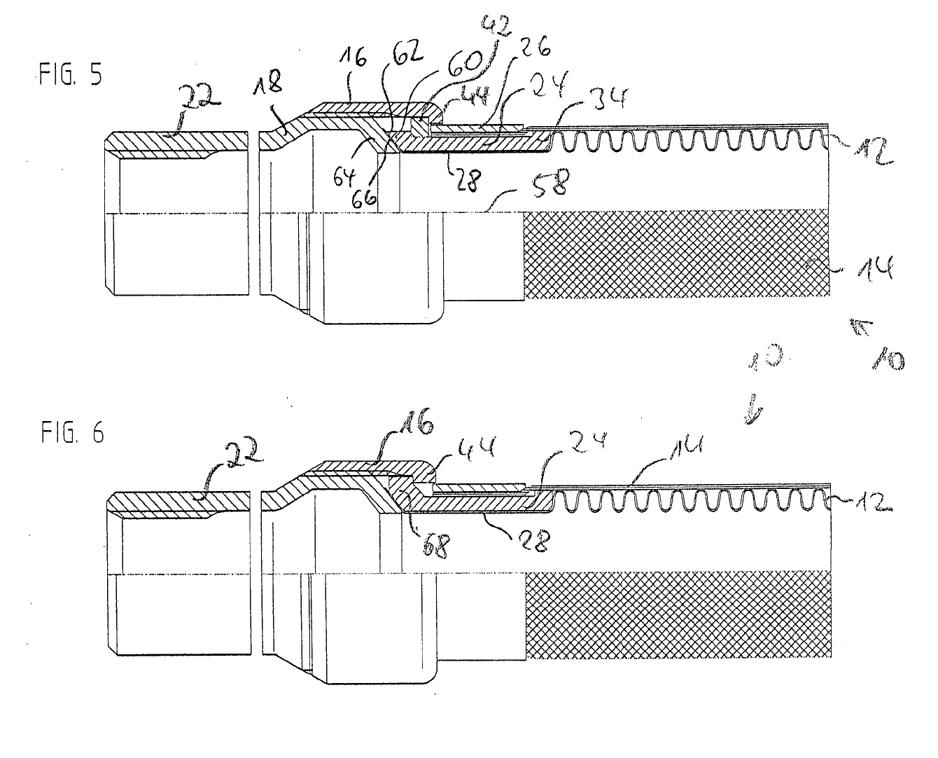

FIG. 5 a third embodiment of a hose,

FIG. 6 a modification of the hose according to FIG. 5,

FIG. 7 a fourth embodiment of a hose,

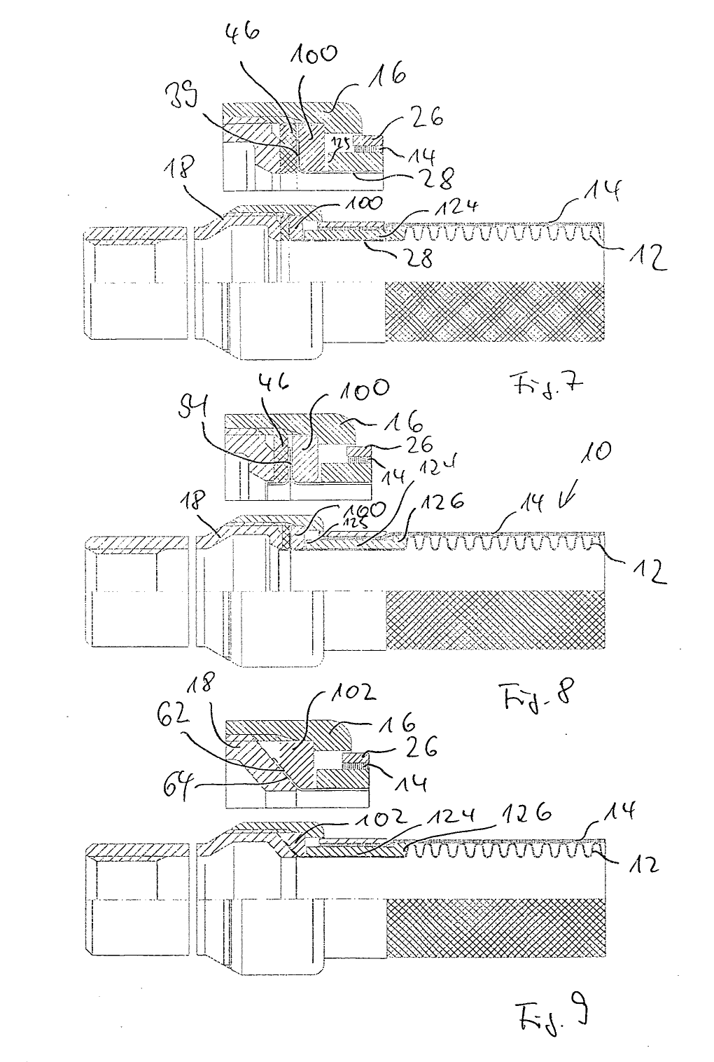

FIG. 8 a first modification of the hose according to FIG. 7,

FIG. 9 a second modification of the hose according to FIG. 7,

FIG. 10 a fifth embodiment of a hose,

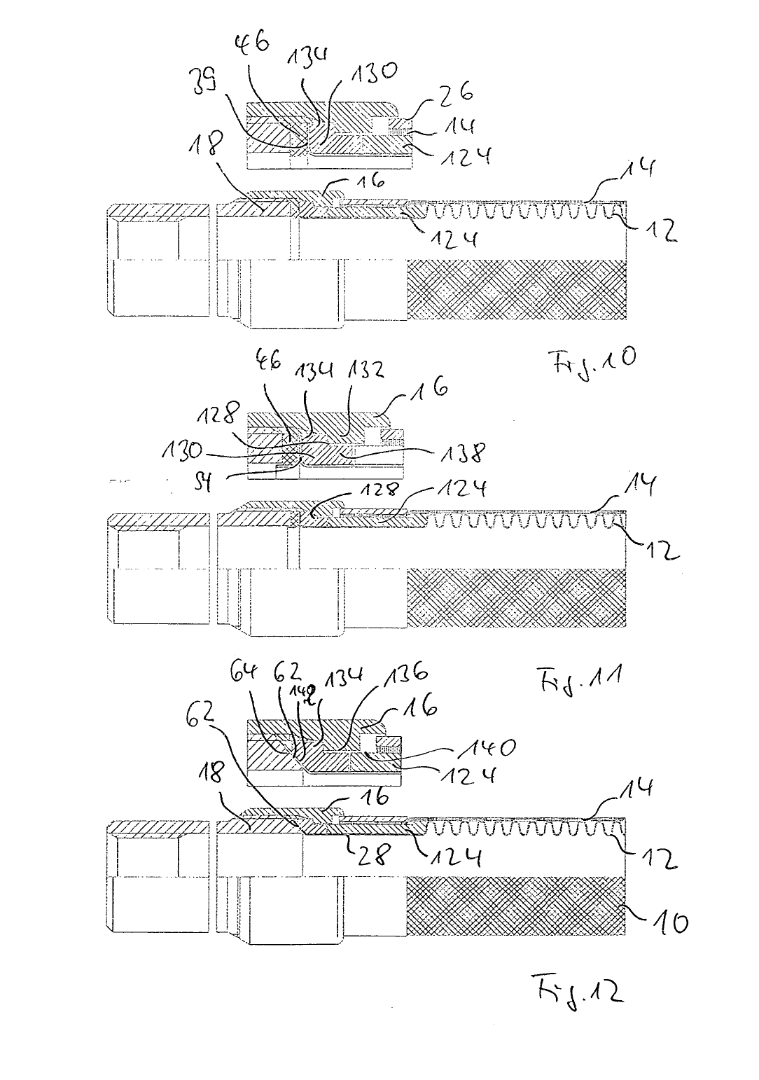

FIG. 11 a first modification of the hose according to FIG. 10,

FIG. 12 a second modification of the hose according to FIG. 10,

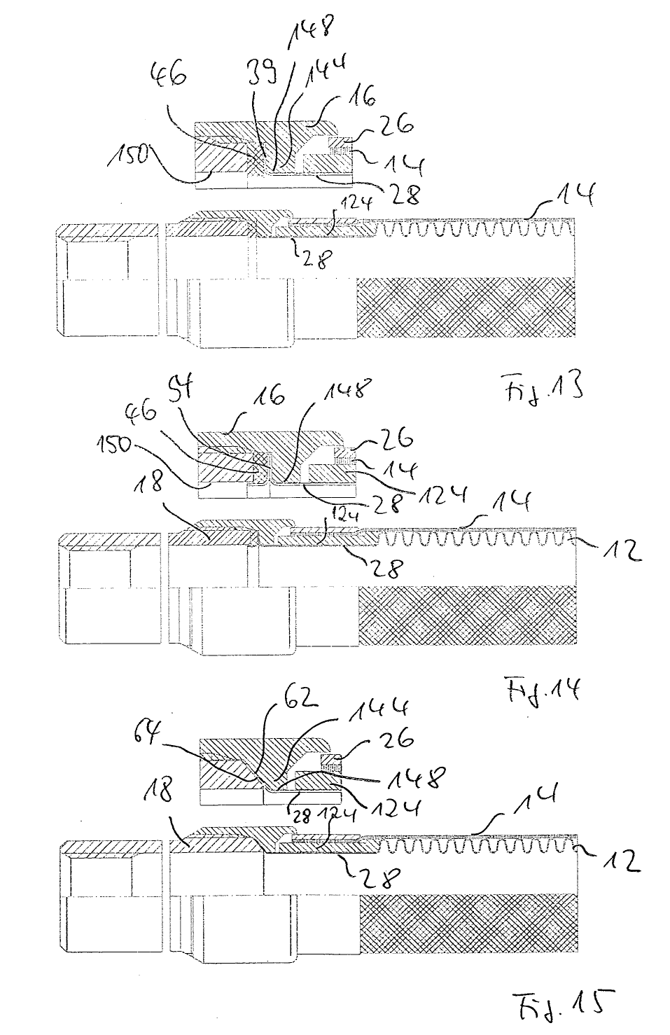

FIG. 13 a sixth embodiment of a hose,

FIG. 14 a first modification of the hose according to FIG. 13, and

FIG. 15 a second modification of the hose according to FIG. 13.

In the figures, in which the same elements are given the same reference numbers, a flexible hose 10 is depicted, which is intended for use in a sprinkler systems in particular. The hose 10 is comprised of an inner corrugated hose 12 and an outer braiding 14.

The hose 10 is connected to a component 18. For this purpose, a coupling-sleeve element 16 proceeds from the hose 10, that e.g. can be screwed to the component 18. The coupling-sleeve element 16 is therefore preferably a coupling nut, without this imposing a restriction on the invention. Other types of connection are also possible. The coupling-sleeve element 16 can therefore also be connected to the component 18 by means of a flange coupling. In the case of component 18, in particular, this is a fitting. Other components, such as pipe connections or pipe manifolds are also possible.

For purposes of simplification, however, the coupling-sleeve element 16 will hereafter be called a coupling nut and the component 18 a fitting.

If the coupling nut 16 features an inner thread 20, the coupling nut 16 can be screwed onto an outer thread of the fitting 18. However, this is not an imperative characteristic. In fact, there can also be a connection between the coupling-sleeve element and the component, for example, via a flange connection.

If the coupling nut 16 has an inside thread it is also possible for the interior to comprise an undercut. All these variants are meant to be included in the teaching of the invention.

In order to enable a pressure-tight connection between the fitting 18 and the pipe 10 via the coupling nut 16, different constructions are possible. However, essential constituent parts are a support sleeve 24 and clamping sleeve 26 that coaxially surrounds it and that can also be referred to as clamping ring, along with a smoothed end section 28 of the corrugated hose 12. In addition, an end section 30 of the braiding 14 extends between the support sleeve 24 and the clamping sleeve 26.

The support sleeve 24, according to FIGS. 1 to 6, displays, in cross section, an H-geometry, that does not feature a transverse limb, with an axially running middle section 32, as well as radially running edges 34, 36, which are bent outward. In other words, the support sleeve 24 is a hollow cylinder with the edges 34, 36 bent outward.

The clamping ring, or as the case may be, clamping sleeve 26, runs between the edges 34, 36, and displays an axial extent that is smaller than the clear distance between the lateral limbs 34, 36.

In order to mount, or as the case may be, secure the coupling nut 16, the coupling nut is first pushed over the hose 10 in an area that runs outside the support sleeve 24. Then the braiding 14 is retracted, so that the support sleeve 24 can be pushed onto the smoothed end section 28 of the corrugated hose 12. The support sleeve 24 is pushed onto the smoothed end section 28 to an extent that a flange-like reshaped end section 39 of the corrugated hose 12, i.e. the end area 28, extends along the radially running outer surface of in the drawing the left edge 36, i.e. along the free front surface 38 of the support sleeve 24. Then the braiding 14 is drawn over the support sleeve 24, and the clamping sleeve 26 is positioned in the area of the support sleeve 24 and around the braiding 14, i.e. the end section 30, for pressing the clamping sleeve 26 subsequently. This results in a force-fit connection of the section 30 of the braiding between the clamping sleeve 26 and the support sleeve 24. The area of the braiding 14, that protrudes beyond the left end of the clamping sleeve 26 in the drawing, is removed.

The flange-like end section 39, which could also be a section of a fold, is an additional essential characteristic of the inventive method. The flange-like end section 39 of the corrugated hose 12 can thereby be configured as single or double, or it can run at an angle to the longitudinal axis of the hose 10. The relevant variations, which also include the fold, will be termed, in a simplified manner, as flange-like end sections.

The clamping sleeve 26 is aligned and fixed in such a way in relation to the support sleeve 24, that a free space remains between a front edge area 40 of the clamping sleeve 26 and the inner surface of the edge 36 of the support sleeve 24 that runs along the fitting side, in order to insert half-shells 42 into the free space that form a ring. The half-shells 42 form a stop for an edge 44 of the coupling nut 16 that is bent inward and is on the far side of the fitting 18, said edge having the function of a shoulder. The clear diameter of the shoulder is thus smaller than the maximum diameter of the half-shells 42 that form the stop. In this way, the coupling nuts 16 cannot override the half-shells 42 that are arranged between the support sleeve 24 and the clamping sleeve 26, said half-shells acting as a counter surface when screwing in the fitting 18.

On the expanded and bent outward, i.e. flange-like end section 39 of the smoothed end area 28 that extends along the radially outer front side 38 of the support sleeve 24, an annular seal 46 is arranged, which—when srewing in the fitting 18 into the coupling nut 20—is pressed into the coupling nut 20 between an inward circumferential section 48 of the fitting 18 and an edge section 39 of the smoothed end section 28 of the corrugated hose 12, thereby assuring the necessary tightness.

If, according to the embodiment in FIG. 1, the ring consisting of the half-shells 42 is provided as a stop to prevent withdrawal of the coupling nut 16 from the hose 10, the same function can be realized by means of a correspondingly extended outer flange or transverse limb 50, aligned radially outward, of the support sleeve 24, as can be seen in FIG. 2.

The embodiment in FIGS. 3 and 4 is different from the one in FIGS. 1 and 2, in that the smoothed end section 28 of the corrugated hose 12 is formed as a fold 52, which consists of a first flange-like section 54 that runs along the front side 38 of the transverse limb 36, and a section 56 that runs vertically to said transverse limb, which presents a shoulder that extends axially. Corresponding to the embodiment of FIGS. 1 and 2, the seal 46 is placed on the section of the smoothed end area 28 of the corrugated hose 12 that runs on the outer, radially running end area 38 of the support sleeve 24, said section being the first section 54 of the fold. The second section 56, which runs axially to the coupling nut 16, extends along the axially running inner edge of the annular seal 46, which therefore runs coaxially to the second section 56. In this way, simple positioning of the annular seal 46 is assured.

According to FIG. 2, the embodiment in FIG. 4 is different from that in FIG. 3 in that the coupling nut 16 does not rest against the ring 42, which consists for example of ceramic material, as the stop when screwing in the fitting 18, but rather directly against the flange or transverse limb 50 of the supporting sleeve 24.

If, according to FIG. 1-4 the annular seal 46 is provided for sealing the fitting 18 against the support sleeve 24, there is also the possibility that the outer flange-like edge area of the smoothed end section 28 of the corrugated hose 12 performs the sealing function. This should be made clear by FIGS. 5 and 6, in which elements that correspond to those of FIG. 1-4 are provided with the same reference numbers.

Deviating from the embodiments in FIG. 1-4, the support sleeve 24 does not feature an outer front surface 60 that runs perpendicular to the longitudinal axis 58, but rather one that runs inclined to the longitudinal axis 58 of the hose 10 and therefore the support sleeve 24, along which front surface the flange-like edge area 62 of the smoothed end area 28 of the corrugated hose 12 runs. Adjusted to the geometry of the course of the front surface 60, a corresponding inward directed section 64 with an external surface 66 proceeds from the fitting 18 and runs parallel to the front surface 60. For this reason, when screwing in the fitting 18, the outer edge area 62 of the smoothed corrugated hose 12 is pressed between the surfaces 60 and 66, thereby exercising the required seal effect.

If, as in FIG. 5, the coupling nut 16 with its inwardly angled edge 44, which runs on the hose side, rests against the ring 42 that runs between the support sleeve 24 and the clamping sleeve 26, then in FIG. 6, corresponding to FIGS. 2 and 4, the flange or outer transverse limb, i.e. the edge 68 of the support sleeve 24 that is bent outward, serves as the stop for the coupling nut 16.

Additional embodiments of the inventive hose 10 that should be pointed out can be seen in FIGS. 7 to 15, all of which, however, feature the features of a support sleeve and a clamping sleeve, which characterize the invention, as well as a flange-like designed end section of the corrugated hose that is smoothed at the end, in order to enable a connection between a coupling-sleeve element, such as a coupling nut, and a component such as a fitting. In this way, according to the embodiments in FIGS. 7 to 15, the axial forces are transferred to the corrugated hose 12 via the flange-like shaped end section.

Regarding the design of the flange-like end section of the corrugated hose, the FIGS. 7, 10, and 13 correspond to the embodiments in the FIGS. 1 and 2, those in FIGS. 8, 11, and 14 and those in FIGS. 3 and 4, and those in the FIGS. 9, 12 and 15 to those in FIGS. 5 and 6.

The embodiments in the FIGS. 7 and 9 also differ from those in the FIGS. 1 to 6 in that as a stop for the coupling nut 16, a separate ring-shaped or hollow-cylinder element 100, 102 is used, by means of which the smoothed end area 28, and specifically its flange-like shaped end section 39, 54, or as the case may be 62, is fixed between the sealing 46, or as the case may be the front surface 64 of the fitting 18, and pressed. In that way, the geometry of the support sleeve 124 deviates from the embodiments of the FIGS. 1 to 6 in that said support sleeve features the form of a hollow cylinder with an edge 126, located on the far side of the fitting and angled outward, that is to say that in cross section, it displays the shape of a T, or as the case may be the shape of two L's. In other words, the support sleeve features an elongated hollow-cylinder geometry with an edge 126 or flange that runs at an angle on the hose-side. Because the support sleeve 124, due to the lack of an edge running at an angle on the fitting-side, cannot serve either indirectly or directly as a stop for the coupling nut 16, the outer diameter can therefore be minimized, whereby however, some ability to displace the coupling nut 16 above the hose 10 along its braiding 14 may be forfeited.

The ring-shaped element 100, 102 is axially dimensioned in such a way that it can be inserted and fit well between the component-side front surface 125 of the support sleeve 24 and the reshaped, flange-like end section 39, 54, 62 of the smoothed end area 28 of the corrugated hose 12, so that tilting is avoided when connecting the coupling nut 16 with the fitting 18. A similar consideration applies to the element forming a stop described below.

In the case of the variation according to FIGS. 10 to 12, the stop for the coupling nut 16 is formed by an annular element 130 that forms an external step 128, said annular element having an L-geometry corresponding to the sectional presentation in FIGS. 10 to 12. A section 132 projects radially inward from the coupling nut 16, said section coming to rest against the radially running limb 134 of the annular element 130 when connecting the coupling nut 16 to the fitting 18, so that as a result, the limb 134 forms the stop. The projection 132 thereby extends with its axially running inner surface 136 both along the axially running limb 138 of the annular element 130, as well as along the outer surface 140 of the support sleeve 124, whose geometry is explained in connection with the FIGS. 7 to 9.

Corresponding to the presentation in FIG. 5, according to FIG. 12, the end section 162 of the smoothed end area 28 of the corrugated hose 12, which is widened into a trumpet shape, is clamped directly between the annular element 134 and the fitting 18, i.e. the front surface 64 of the fitting. In order to achieve this, the front surface 64 and the facing surface 140 of the annular element 134 run at an angle to the longitudinal axis of the hose 10 and therefore to the supporting sleeve 124, or as the case may be, the coupling 16, and the other elements connected to them.

Correspondingly, according to FIG. 9, there is direct clamping of the trumpet-shaped end section 62 between the annular element 102 and the fitting 18.

The FIGS. 13 to 15 differ from the previously described embodiments in that the stop for the sleeve 16 is formed by the fitting 18 itself the moment the coupling nut 16 is connected to the fitting 18, and the flange-shaped end section 39, or as the case may be 54 or 62 of the corrugated hose 12 is clamped between the coupling nut 16 and the fitting 18, or as the case may be, between the fitting and the sealing 46 that runs between it and the flange-shaped end section 39, 54.

As unequivocally demonstrated by FIGS. 13 to 15, the coupling nut 16 features an inwardly projecting, circumferential projection 144, which extends almost to the outer side of the smoothed end area 28 of the corrugated hose 12. This is seen particularly in the detailed drawings in the FIGS. 13 to 15. The inner surface of the projection 144 therefore extends approximately along a plane in which the inner surface 150 of the fitting 18 lies. In this way, high press capacity can be produced, by means of which the flange-like section 39, 54, or as the case may be 62 of the smoothed end area 28 of the corrugated hose 12 can be sufficiently firmly fixed.

In other respects, the constructive characteristics of the FIGS. 13 to 15 correspond to those of FIGS. 7 to 12, so that reference can be made to explanations concerning them.

1. A flexible hose (10), particularly a sprinkler hose, comprising an inner corrugated hose (12), which is surrounded on the outside by a braiding (14), as well as a coupling-sleeve element (16), such as a coupling nut, that is connected to the hose on the end side, for connection with a component, such as a fitting (18), characterized in that the corrugated hose (12) is smoothed on the end side; that a support sleeve (24) runs between the smoothed end area (28) of the corrugated hose and the braiding (14); that the braiding is fixed between the support sleeve and a clamping sleeve (26) surrounding the support sleeve; that the smoothed end area is surrounded by the coupling-sleeve element (16), which features a shoulder (44, 132, 144) that extends in the direction of the support sleeve, whereby in the case of the coupling sleeve element that is connected to the component (18), a stop element (42, 50, 68, 100, 130) that acts against withdrawal of the coupling-sleeve element from the hose is assigned to said coupling-sleeve element, and a flange-shaped end section (39, 54, 62) of the smoothed end area of the corrugated sleeve is fixed between the coupling-sleeve element and the component.

2. Hose according to claim 1, characterized in that the stop element is a section (50) of the support sleeve (24) and/or the clamping sleeve (26).

3. Hose according to claim 1, characterized in that the stop element is an element secured by the support sleeve (24) and/or the clamping sleeve (26) such as an annular element (42), preferably in the form of composite half-rings or half-shells.

4. Hose according to claim 1, characterized in that the stop element is a ring or hollow-cylinder element (100, 130) that runs between the support sleeve (124) and the reshaped, flange-like end section (39, 54, 62) of the smoothed end area (28) of the corrugated hose (12).

5. Hose according to claim 1, characterized in that a sealing element, such as a sealing ring (46), runs between the flange-like, reshaped end section (39, 54) and the component (18).

6. Hose according to claim 1, characterized in that the coupling-sleeve element (16), such as a coupling nut, rotateably encompasses the hose (10).

7. Hose according to claim 1, characterized in that the flange-like shaped end section (39, 54, 62) of the corrugated hose (12), which is smoothed at the end side, can be fixed directly between the support sleeve (24) and the sealing element (46).

8. Hose according to claim 1, characterized in that the flange-like, reshaped end section (39, 54) of the corrugated hose (12) can be fixed directly between the coupling-sleeve element (16, 144) and the sealing element (46).

9. Hose according to claim 1 characterized in that the flange-like shaped end section (62) of the corrugated hose (12) that is smoothed at the end side, can be fixed directly between the support sleeve (24) and the component (18).

10. Hose according to claim 1, characterized in that the support sleeve (24), on the coupling-sleeve side, features a circumferential edge (50) that projects radially outward, the outside diameter of said edge being greater than the clear inner diameter of the shoulder (44) of the coupling-sleeve element (16).

11. Hose according to claim 1, characterized in that the support sleeve (24) features a hollow-cylinder form, with a component-side edge (126) on the far side, which is bent outward, and that the front surface (125) running on the component side features a distance to the flange-like shaped end section (39, 54) of the corrugated hose (12) that is smoothed on the end side, said distance being equal to or slightly larger than the axial reach of the stop element (100, 102).

12. Hose according to claim 1, characterized in that the support sleeve (24) features a hollow-cylinder form with edges (34, 36, 50, 64, 68) that are bent outward on the end side, between which the clamping sleeve (26) runs.

13. Hose according to claim 1, characterized in that seen in an axial direction, between the edge (36) of the support sleeve (24) running on the component side and the clamping sleeve (26), runs an element as the stop element, said element concentrically surrounding the support sleeve (24) and preferably taking the form of composite half-rings or half-shells (42), the outer diameter of said element being greater than the clear inner diameter of the inward-directed edge, or as the case may be shoulder (44) of the coupling-sleeve element (16).

14. Hose according to claim 1, characterized in that the flange-like shaped end section (39) of the end-side smoothed corrugated hose (12) extends along the radially running front surface (38) of the support sleeve (24).

15. Hose according to claim 1, characterized in that when the component (18) is connected to the coupling-sleeve element (16) a radially inward projecting section (144) of the coupling-sleeve element rests against the far component-side surface of the flange-shaped end section (39, 54) of the smoothed corrugated hose (12), and that the sealing element (46) or the component rests against the opposite surface.

16. Hose according to claim 1, characterized in that the front side (60) of the support sleeve (24), that runs on the component-side, runs, at least in sections, at an angle to its longitudinal axis (58); that the flange-like shaped end section (62) of the corrugated hose (12), which is smoothed at the end side, extends along the front surface; and that when the coupling-sleeve element (16) is connected to the component (18), the end section is fixed in a sealing manner directly between the front surface of the support sleeve and the component.

17. Hose according to claim 1, characterized in that the surface of the stop element (102), that runs along the component-side, runs, at least in sections, at an angle to the longitudinal axis of the hose (10); that the flange-like shaped end section (62) of the corrugated hose (12), which is smoothed at the end side, extends along the front surface; and that when the coupling-sleeve element (16) is connected to the component (18), the end section is sealingly fixed directly between the front surface of the stop element and the component.

18. A method of mounting a coupling-sleeve element (16) such as a coupling nut on a flexible hose (10), such as a sprinkler hose, comprising an inner corrugated hose (12), which is surrounded on the outside by a braiding (14),
characterized by the procedural steps
retracting the braiding (14) from one end of the corrugated hose (12),
smoothing the exposed end area of the corrugated hose,
pushing a support sleeve (24) onto the smoothed end area of the corrugated hose,
surrounding the support sleeve with the braiding drawn over it,
surrounding the support sleeve in its area surrounded by the braiding, at least in sections, by a clamping sleeve (26),
force-fit connection of the clamping sleeve to the support sleeve,
reshaping of the smoothed corrugated hose that axially overlaps the support sleeve into a flange-shaped section (39, 54, 62),
whereby the coupling sleeve element (16) is pushed over the hose (10), before or after applying the support sleeve, and the support sleeve and/or the clamping sleeve and/or an element (42) that is inserted between the flange-like section of the smoothed corrugated hose and the support sleeve, and/or a component (18) that can be connected to the coupling-sleeve element serves as a stop against withdrawal of the coupling-sleeve element.
